(19) United States
(12) Patent Application Publication
(10) Pub. No.: US 2007/0292564 A1
(43) Pub. Date: Dec. 20, 2007

(54) High dry matter suspension for liquid animal feed

(75) Inventors: Jiang Hu, Ankeny, IA (US); Michelle P. Moore, Des Moines, IA (US); Jennifer Radosevich, Ankeny, IA (US); Jed Harms, West Des Moines, IA (US); Rolland Nelson, Clive, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(73) Assignee: Kemin Industries, Inc., Des Moines, IA (US)

(21) Appl. No.: 11/810,468

(22) Filed: Jun. 6, 2007

Related U.S. Application Data
(60) Provisional application No. 60/811,293, filed on Jun. 6, 2006.

(51) Int. Cl. A23L 1/10

(52) U.S. Cl. 426/31

(57) ABSTRACT

Described are stable, starch-rich liquid animal feed suspensions having a high dry matter content and which do not require added heat or suspension agents for starch gelatinization and stabilization of the suspensions. Enzymatic hydrolysis and mechanical grinding are used to release starch and produce a gel-like suspension from a starting grain product, such as seeds or kernels of corn, wheat, barley, millet, oats, or rice, or flours made from the grain seeds or kernels combined with a plant processing by-product such as dried distillers grain solubles, condensed beet molasses solubles, whey, and corn steep liquor. The products produced through the processes of the present invention are flowable, dark brown to golden, gel-like suspensions with a pH of 5-7 and viscosities of 500-1000 cP at ambient temperature. In addition, the products had comparable nutritional profiles to a commercial liquid feed supplement.

This application claims priority to U.S. Patent Application Ser. No. 60/811,293, filed Jun. 6, 2006.

### BACKGROUND OF THE INVENTION

The invention relates generally to animal feeds and, more specifically, to a stable, starch-rich liquid animal feed with high dry matter content and which does not require added heat or suspension agents for starch gelatinization and stabilization of the suspension.

Limited intake or bioavailability of nutrients results in low animal productivity especially for grazing cattle fed on poor quality range forage. It has been a common practice to provide cattle supplemental nutrients such as minerals and proteins via various forms. The use of molasses-based liquid feed supplements for beef cattle enhances digestibility of dry matter and the cereal residue of forage (Araba, A., Byers, F. M. and Guessous, F. Food Industry by-product strategies to enhance carbohydrate fraction digestion and to limit fossil energy intensive starch needs in cereal-residue diets for beef cattle. Livestock Research for Rural Development. 2001 (13); Arthington, J. D. and Pate, F. M. Effect of corn vs. molasses-based supplements on trace mineral status in beef heifers. Journal of Animal Science. 2002; Kalmbacher, R. S., Brown, W. F. and Pate, F. M. Effect of Molasses-Based Liquid Supplements on Digestibility of Creeping Bluestem and Performance of Mature Cows on Winter Range. Journal of Animal Science 1995).

Including starch-rich grain material into feed or feed supplements for livestock provides additional nutritional value and improves the feed efficiency for the animals. Previous work has demonstrated that partially replacing dry grain in cattle fed with a heat-processed liquid corn starch material (StarLass™, Kemin Industries, Des Moines, Iowa) increased cattle feed consumption and weight gain with a reduced cost. The same material was also used in poultry feed and increased the average daily weight gain and performance of the broilers. Traditionally, dry grain material has not been widely applied in liquid feed products due to lack of suspension stability. Previously, to make a stable feed suspension with starch-rich grains, it has required hydrothermal and/or high-pressure processing to gelatinize starch molecules in order to stabilize the suspension. The StarLass™ liquid starch suspension product was produced through a jet-cooking process. Although the process is commercially viable, it has certain limitations such as the relatively high cost of energy and capital expenditure. Other thickening/suspending agents such as phospholipids, gums, clays and the like have been used to stabilize suspensions of insoluble ingredients in the liquid animal feed or feed supplements (U.S. Pat. Nos. 4,219,572 and 4,267,197; United States Patent Appl. Publ. No. US 2002/0150608). However, these aids are nutritionally inert and therefore not economically beneficial.

Corn steep liquor (CSL) is a by-product of the wet corn milling industry that contains a mixture of carbohydrates, amino acids, peptides, organic compounds, heavy metals, inorganic ions, and myo-inositol phosphates (Hull, S., Yang, Byung., Venzke, David., Kulhavy, Kurt., and Montgomery, R. Composition of Corn Steep Water during Steeping. J. Agric. Food Chem. 1996, 44, 1857-1863). The relatively low cost of CSL and the fact that over 1.3 billion pounds is produced annually nationwide makes CSL a cost-effective aqueous nutritive medium (McNamara, S. Corn Part of Our Daily Lives. Corn Annual Report, Corn Refiners Association, Inc. Washington, D.C. 2005; pp 2-19. Web site: www.corn.org).

Molasses-based liquid feed supplements are fed to cattle receiving forage-based diets because they have been shown to enhance digestibility of dry matter (DM) and the cereal residues of forage (Araba, et al. 2001; Arthington and Pate, 2002; Kalmbacher, et al. 1995). In the period from 2004 to 2006 the price of molasses doubled, driving manufacturers to source other raw material replacements. Additionally, the nutrient profile of molasses has been decreasing because the extraction process of sugar has become more refined (see, U.S. Pat. No. 5,358,571). Whey has been found to be a suitable nutrient replacement for molasses and is utilized by many manufactures of liquid animal feeds (Galloway, D., Goetsch, A., Sun, W., Forster, L., Murphy, G., Grant E., and Johnson, Z. J. Anim. Sci. 1992. 70:2533-2541; Schingoethe D. 1976. Whey utilization in animal feeding: a summary and evaluation. J. Dairy Sci., 59(3): 556-570).

Condensed beet molasses solubles, sometimes shortened to condensed molasses solubles or CMS, is the liquid co-product resulting from the molasses de-sugaring process and has uses as a liquid cattle feed.

The products representing preferred embodiments of the present invention are intended to be used as a liquid carrier for a feed supplement or to be used alone to substitute a portion of dry grain or pelleted feed.

### SUMMARY OF THE INVENTION

The present invention consists of a stable, partially starch-rich liquid animal feed suspension having a high dry matter content and which, in preferred embodiments, does not require added heat or suspension agents for starch gelatinization and stabilization of the suspension. Enzymatic hydrolysis and mechanical grinding are used to release starch and produce a gel-like suspension from a starting grain product, such as seeds or kernels of corn, wheat, barley, millet, oats, or rice, or flours made from the grain seeds or kernels combined with a plant processing by-product such as dried distillers grain solubles, condensed beet molasses solubles, corn steep liquor, and whey. The ratio of the grain to the plant by-product is between about 1:1 and about 1:9, and preferably between 1:2 and 1:6, and most preferably at least 65 percent plant by-product. Enzymes useful in the process include proteases, amylases, keratinases, and starch debranching enzymes, such as, isoamylase, amyloglucosidase and, particularly, pullulanase. Suspensions made from ground corn of 850 μm or smaller particle size were more homogenous and stable than suspensions made from ground corn with a larger particle size. Suspensions made under preferred embodiments of the present invention were stable for greater than three days, preferably greater than seven days, more preferably greater than fourteen days, and most preferably greater than 60 days despite the fact that little or no exogenous heat was applied or no thickening agents were employed.

The products produced through the processes of the present invention are flowable, dark brown, gel-like suspensions with a pH of between about 4 and about 8, and preferably between about 5 and about 7, and viscosities of between about 600 and about 2000 cP, and preferably between about 300 and about 1040 cP, and even more preferably between about 500 and about 800 cP, at ambient temperature. In addition, the products had comparable nutritional profiles to a commercial liquid feed supplement. Liquid animal feed suspensions of the present invention may be fed to mammals, including ruminants such as cattle and sheep, as well as non-ruminants such as swine, poultry, and companion animals.

### DETAILED DESCRIPTION OF PREFERRED EMBODIMENTS

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods and materials are described below. All publications, patent applications, patents, and other documents mentioned herein are incorporated by reference in their entirety. In case of conflict, the present specification, including definitions, will control. However, the materials, methods, and examples are contemplated to be illustrative only and not intended to be limiting. If a range of values is provided, the range includes all values between the maximum and minimum values of the range.

Corn steep liquor (CSL), sometimes referred to as condensed fermented corn extractives, as used in this disclosure is a by-product of the wet corn milling industry that contains a mixture of carbohydrates, amino acids, peptides, organic compounds, heavy metals, inorganic ions, and myo-inositol phosphates.

Condensed beet molasses solubles, sometimes referred to as desugared beet molasses, condensed beet solubles, or condensed beet molasses solubles (CMS), as used in this disclosure, is the liquid co-product resulting from the molasses de-sugaring process.

Dried distillers grains (DDG) or dried distillers grains with solubles (DDGS) are ethanol plant by-products/co-products remaining after fermentation. Other combinations of corn flour and CMS and/or CSL may be combined with small amounts of plant by-products such as gluten meal, gluten feed, corn germ meal, or corn bran with distiller's solubles (DBRAN).

Whole whey is a dilute solution of lactalbumin, lactose, some fats, and the soluble inorganics from the parent milk. The whey is commonly condensed and spray dried to a powder or is condensed to about 40 to 60 percent solids, the balance being water, and preserved. A typical analysis is protein 12.0%, fat 0.7%, lactose 60.0%, phosphorous 0.79%, calcium 0.87%, and ash 9.7%. Delactosed whey results from lactose crystallization from whole whey, and consequently has a greater concentration of protein and ash. A typical analysis of delactosed whey is protein 24.0%, fat 1.0%, lactose 50.0%, ash 20-25%, and salt 5-7%. Most delactosed whey is used as an ingredient in milk replacers and other relatively high-end value products. There is a significant quantity of this by-product, however, which is not suitable for such end uses, frequently because of low protein or high salt contents. The use of this product in animal feed supplements is hindered as it is impractical to concentrate delactosed whey, as gels are formed in concentrates with solids over 35 weight percent. Additionally, the maximum solubility of lactose at ambient temperatures is about 20 weight percent, and lactose will crystallize from delactosed whey when cooled to ambient temperatures.

Enzymes as used in this disclosure include proteases, keratinases, amylases, and starch debranching enzymes, such as isoamylase, amyloglucosidase, and pullulanase. Pullulanase, a preferred debranching enzyme, is a specific kind of glucanase, specifically an amylolytic exoenzyme that degrades pullulan. It is also sometimes referred to as pullulan-6-glucanohydrolase and is known as a starch debranching enzyme. Type I pullulanases specifically attack α-1,6 linkages, while type II pullulanases are also able to hydrolyze α-1,4 linkages.

As used in this specification, high dry matter content means the percent of feed that is not water and is typically greater than 50%, more typically greater than 55%, most preferably greater than 60%.

As used in this specification, stable means a homogeneous mixture that does not separate into visible layers.

As used in this specification grain and grain products include whole and ground corn, wheat, rice, barley, millet, rye, sorghum, and oats.

### EXAMPLES

### Example 1

### Grain Product and Condensed Beet Molasses Solubles

Materials and Methods

Materials: Dry whole corn kernels (moisture content 14.5%) were purchased from Des Moines Feed Company (Des Moines, Iowa). When necessary, whole kernels were further ground (Thomas-Wiley Laboratory Miller) into corn flour of various particle sizes. Particle size (d_{gw}) and distribution of corn flour samples were assessed indirectly using a sieve shaker and Equations 1 and 2 below. Standard deviation (S_{gw}) of the d_{gw} was derived from Equation 3 below (Baker, S. and Herrman, T. 2002. MF-2051 Evaluating particle size. Kansas State University pp 1-6).
dᵢ=(dᵤ×dₒ)^{0.5} Equation 1
Where:
dᵢ=diameter of i^{th} sieve in the stack
dᵤ=diameter opening through which particles will pass (sieve preceding i^{th})
dₒ=diameter through which particles will not pass (i^{th} sieve)

$$\begin{matrix}{d}_{gw} = {log}^{- 1} [ \frac{\sum ( {W}_{i} log {d}_{i} )}{\sum {W}_{i}} ] & Equation 2 \\ {S}_{gw} = {{log}^{- 1} [ \frac{\sum {( {W}_{i} log {d}_{i} - log {d}_{gw} )}^{2}}{\sum {W}_{i}} ]}^{0.5} & Equation 3\end{matrix}$$

Condensed beet molasses solubles (CMS, density 1.3 g/ml, pH 8) and the liquid feed supplement (LFS) product were provided by Biegert Enterprises, Inc. (Bradshaw, Nebr.). Protease (bromelain, 1000 CDU/mg) was purchased from Sigma-Aldrich (St. Louis, Mo.). Pullulanase (Dextrozyme®, 510 NPUN/g) and α-amylase (Validase®, 340000 MWU/g) were supplied as gifts by Novozyme (Bagsvaerd, Denmark). The mold inhibitor GrainShield® was supplied by Kemin AgriFoods North America (Des Moines, Iowa). Sulfur dioxide (SO₂) used in the experiments was generated from 88% lactic acid and sodium metabisulfite (Fisher Scientific, NJ). All other chemicals and supplies were purchased from Fisher Scientific (Pittsburgh, Pa.).

Measurements: The pH was measured using pH indicator strips (Fisher Scientific). The viscosity was measured using a DV-II+viscometer (Brookfield Engineering, Middleboro, Mass.). The moisture, dry matter, crude protein, fiber content, and energy profile of the samples were analyzed by Eurofins Scientific, Inc. (Des Moines, Iowa). Suspension stability was measured as the number of days that samples stayed homogenous and did not separate into layers.

Process Development

The initial experiments were conducted to assess the feasibility of the process using corn as grain material in both whole dry kernel and flour forms. Three processes were tested for whole corn kernels and two for corn flour. The pH and stability of the resulting samples were measured. The resulting samples were all stored in a container covered with Parafilm® (Pechiney Plastic, Chicago, Ill.) at ambient temperature.

Corn kernel processes: The processes for corn kernels included an initial soaking step to hydrate the kernels. The three processes differed only in the soaking solution, which was tap water, 1M NaOH, or water with 2000 ppm of SO₂. One hundred grams of dry corn kernels were steeped in 200 ml of soaking solution for 4 hours at ambient temperature. The hydrated corn kernels were then separated from the steep liquor and coarsely ground. The corn paste was further mixed with 100 ml of CMS, and adjusted to pH 4-5 with 12 N HCl. The mixture was incubated with 0.8 g of bromelain (8,000 CDU), 2 g of pullulanase (1020 NPUN), 2 g of α-amylase (680,000 MWU) and 500 ppm SO₂ at ambient temperature for 2-3 hours. The enzymatic hydrolysis was stopped by addition of phosphoric acid to the mixture up to 1% (w/w). The mixture was liquefied with a high-speed blender (Oster, 12 speed) at a high shear setting for 4 minutes. Thereafter 133 ml of CMS was blended in under a low shear setting for 1 minute and followed by gently stirring GrainShield into the suspension to up to 0.5% (w/w) to control mold growth.

Corn flour processes: The two processes for corn flour were both tested with two different flour particle sizes, ≦2000 and ≦850 μm. Dry corn kernels were ground to flour of the particle size desired. In Process 1, 100 g of corn flour was mixed with 100 ml of CMS which was adjusted to pH 4-5 with 12 N HCl, and incubated with 0.8 g of bromelain, 2 g of pullulanase, 2 g of α-amylase and 500 μm SO₂ at ambient temperature for 2-3 hours. The enzymatic hydrolysis was stopped by addition of phosphoric acid to the mixture up to 1% (w/w). The mixture was liquefied with a high shear blending force for 4-5 minutes. The final step was the addition of 133 ml of CMS, blending under a low shear setting for 1 minute, and followed by stirring GrainShield into the suspension to up to 0.5% (w/w). In Process 2, an additional step was taken prior to the enzyme treatment. The corn flour was pretreated with 100 ml of CMS for 1 hr which was adjusted to pH 10-11 with 50% NaOH (w/v) at ambient temperature. Then the pH was adjusted back to pH 4-5 with 12 N HCl and the process was continued with enzyme addition. The rest of the steps were the same as described in Process 1.

Process Condition Optimization

The impact of enzyme, SO₂, and HCl on the suspension stability was evaluated to optimize the process conditions and reduce cost. The pH, viscosity, and stability of the resulting samples were measured.

Optimization of enzyme combination and levels: Six different enzyme treatments were applied to both corn flour process 1 and 2: (1) 8 mg/g corn flour of bromelain, 20 mg/g corn flour of pullulanase and 20 mg/g corn flour of α-amylase (positive control); (2) 20 mg/g of pullulanase and 20 mg/g α-amylase; (3) 20 mg/g of α-amylase; (4) 20 mg/g of pullulanase; (5) 2 mg/g of pullulanase; and (6) no enzyme (negative control).

Acidification of CMS: The amount of HCl used for pH adjustment in Process 1 was assessed to determine the minimal requirement for pH adjustment of CMS. The amount of HCl used to acidify CMS in Process 1 was added at 4 levels, 0, 5, 8, 10 ml of 12 N HCl per 100 ml of CMS. The process used in this experiment involved adding only pullulanase at the 2 mg/g corn level based on the optimized enzyme condition.

Effect of SO₂: The requirement of SO₂ during the enzyme incubation was evaluated by testing Process 1 in the presence or absence of 500 ppm of SO₂. The process used in this experiment involved adding only pullulanase at the 2 mg/g corn level and HCl at the 8 ml level.

Results and Discussion

Initial Process Development

Some preliminary work was conducted which established the basic conditions of the process such as the length and shearing force of grinding steps, soaking and incubation time, and the ratio of corn material to CMS. During this initial stage, it was determined that foaming should be minimized during blending because it increased the viscosity of the suspension and decreased stability. The product produced was a flowable, dark brown, gel-like suspension with pH of 5-7 and viscosity of 500-800 cP at ambient temperature.

Corn kernel processes: The processes for corn kernels included an initial soaking step to soften the kernels and disrupt the protein matrix, which aided the further starch release and enzyme penetration. The processes were tested with three types of soaking solutions: water, caustic NaOH solution, or SO₂ solution which simulated the conventional corn wet-milling process (Johnston, D. B. and Singh, V. Use of protease to reduce steep time and SO₂ requirements in a corn wet-milling process. Cereal Chemistry. 78:4, 2001). The stability of the corn kernel processes with different soaking solutions appeared to be different, with 1M NaOH soaking solution resulting in the longest shelf life in terms of suspension stability. The suspensions separated into layers after 4-5, 7-8, and 14 days for soaking solutions of tap water, SO₂, and NaOH, respectively. The pH of the resulting suspension was in the range of 4-5 and apparently not different among the three processes.

Corn flour processes: Two processes for corn flour were tested, one involving pre-soaking corn flour with CMS pH adjusted with NaOH (Process 1) and the other which omitted this step (Process 2). The stability and pH data for the two processes are presented in Table 1. The suspensions were stable for a range of 3-10 days at ambient temperature. Expectedly, the particle size of corn flour apparently had an impact on the suspension stability. It was observed that corn flour of ≦850 μm particle size yielded a more homogenous and stable suspension than corn flour of ≦2000 μm particle size. Therefore, all the subsequent process optimization experiments were conducted with corn flour of ≦850 μm particle size. The pH of the resulting suspension was in the range of 5-6 and did not differ between the two processes. The corn flour process typically requires 4-5 hours to complete.

TABLE 1
The pH and stability of the suspensions
produced by the two corn flour processes

| | Process 1 (without NaOH) | | Process 2 (with NaOH) | |
|---|---|---|---|---|
| Particle size | ≦850 μm | ≦2000 μm | ≦850 μm | ≦2000 μm |
| pH | 5-6 | 5-6 | 5-6 | 5-6 |
| Stability (days) | 10 | 7 | 9 | 3 |

Effect of Enzyme Treatment

Six different enzyme treatments were tested individually using the two corn flour processes. The pH, viscosity, and suspension stability of the products resulting from these different treatments are summarized in Table 2. The results showed that the suspension without enzyme treatment had the shortest stability, suggesting that enzymes played an important role in stabilizing the suspension possibly by disrupting the protein matrix, releasing starch, and inducing gelatinization. It appears that treating the corn flour with pullulanase, a starch debranching enzyme, either alone or mixed with amylase and protease was able to provide the desired stability of the product. Furthermore, the reduced amount of pullulanase in the reaction (2 mg/g corn, equivalent to 102 NPUN/g corn) did not compromise the pH, viscosity, or stability of the suspension. The results were comparable between the two processes regardless of enzyme treatments. Therefore, further experiments were carried out under the condition of 2 mg pullulanase/g corn and using corn flour Process 1.

TABLE 2
The pH, viscosity and stability of the suspensions produced with
different enzyme treatments using the corn flour processes

| | Treatment | | | | | |
|---|---|---|---|---|---|---|
| | A (n = 6) | B (n = 2) | C (n = 2) | D (n = 4) | E (n = 6) | F (n = 4) |
| pH | 5-7 | 4 | 4 | 5-6 | 5-6 | 5-6 |
| Viscosity (cP) | 565-665 | N/A | N/A | 500-660 | 620-700 | 575-645 |
| Stability (days) | 6-12 | 12-15 | 7-10 | 6-15 | 9-13 | 3-7 |

Treatment assignment: A - 8 mg/g corn flour of bromelain, 20 mg/g of pullulanase and 20 mg/g of α-amylase; B - 20 mg/g of pullulanase and 20 mg/g α-amylase; C - 20 mg/g of α-amylase; D - 20 mg/g of pullulanase; E - 2 mg/g of pullulanase; F - no enzyme.
N/A: not measured.

Acidification of CMS

Hydrochloric acid was used in the corn flour processes primarily to adjust the pH of CMS to the range at which the enzymes function. Since the working pH of the pullulanase was relatively broad (pH 4 to 9), the experiments were carried out to determine the minimal amount of 12 N HCl required in the process without compromising the stability of the suspension. Four levels of HCl were tested with Process 1. The pH of the CMS after adjustment was 8.0, 5.6, 5.0, 4.5, for 0, 5, 8, and 10 ml HCl per 100 mL of CMS, respectively. Table 3 shows the suspension properties of the resulting products. The observed lowest dose of HCl required was 80 ml/L in this experiment. The effect of HCl on the stability was dose-dependent. It should be noted that strong acids other than HCl, including the other hydrogen halides, the oxyacids of halogens, sulfuric acid, and nitric acid, can be substituted provided that the amount used is adjusted to provide a final pH of the CMS similar to that when HCl is used.

TABLE 3
The pH, viscosity and stability of the suspensions produced
with different levels of HCl using corn flour process 1

| HCl (ml/L CMS) | 0 (n = 2) | 50 (n = 2) | 80 (n = 2) | 100 (n = 6) |
|---|---|---|---|---|
| pH | 6-7 | 6 | 5-6 | 5-6 |
| Viscosity (cP) | 620-665 | 910-1055 | 500-535 | 550-580 |
| Stability (days) | <1 | 3 | 5-6 | 9-13 |

Effect of SO₂ Treatment

Using SO₂ during the enzyme incubation is thought to help to break the disulfide bonds holding the protein matrix together (Johnston, D. B. and Singh, V. Use of protease to reduce steep time and SO₂ requirements in a corn wet-milling process. Cereal Chemistry. 2001). Accordingly, the necessity of the presence of SO₂ and its effect on the product properties was evaluated. The results showed that the pH and viscosity of the resulting products processed without SO₂ were pH 6 and 495 cP which was not different from the products with SO₂. Both treated and untreated suspensions reached 6 days of stability.

Mixture of the Suspension with Liquid Supplement

Since the suspension produced from the process could eventually be mixed with other ingredients such as minerals and urea to produce the final liquid feed supplement, it was important to evaluate how well the suspension could be mixed with other ingredients in a feed supplement. Without limiting the application of suspension to any specific formula of a commercial feed supplement, a suspension using corn flour combined with CMS and enzyme was mixed with the commercial product at the ratio of 1:1. The mixture was a light brown color suspension with pH of 5-6, viscosity of 440-600 cP and showed no signs of separation for a minimum of 20 days. With these properties, the mixed product could be satisfactory for its application in that the product is in most instances consumed or applied to dry animal feed within 20 days.

Comparison of Nutritional Profiles of the Suspension and the Commercial LFS

The ration cost and animal performance can be substantially influenced by the nutritional value of the feed. Feed tests are important to understand the nutrient composition, quality, and value of the feed products. Two suspensions were prepared following preferred Process 1 and Process 2. In preferred Process 1, 100 g of corn flour (≦850μ) and 100 ml of CMS which was adjusted to pH 4-5 with 8 ml of 12 N HCl, and incubated with 0.2 g of pullulanase, at ambient temperature for 2.5 hours. The enzymatic hydrolysis was stopped by addition of phosphoric acid to the mixture up to 1% (w/w). The mixture was liquefied with a high shear blending force for 4 minutes. The final step was the addition of 133 ml of CMS, blending under a low shear setting for 1 minute, and followed by stirring GrainShield® into the suspension to up to 0.5% (w/w). In preferred Process 2, an additional step was taken prior to the enzyme treatment. The corn flour (100 g, ≦850μ) was pretreated with 100 ml of CMS for 1 hr which was adjusted to pH 10-11 with 2 ml of 5M NaOH at ambient temperature. Then the pH was adjusted back to pH 4-5 with 6 ml of 12 N HCl and the process was continued with enzyme addition (0.2 g of pullulanase). The rest of the steps were the same as described in Process 1. The suspensions produced through the preferred processes were thus analyzed for the primary nutritional parameters such as moisture, dry matter, protein, and energy, which were compared with the commercial LFS, molasses, and CMS. The results are summarized in Table 4. Overall the new products had comparable nutritional profiles to the commercial LFS, indicating that using the new product as the dry matter carrier may not alter the nutritional value of the feed supplement.

TABLE 4
Comparison of Nutritional Values for Beet Molasses,
Condensed Molasses Solubles (CMS), Liquid Feed Supplement
(LFS), and preferred suspensions*

| | | | | Pre- | Pre- |
|---|---|---|---|---|---|
| | Beet | | | ferred | ferred |
| | molas- | | | pro- | pro- |
| | ses¹ | CMS | LFS² | cess 1 | cess 2 |
| Moisture (%) | 21.30 | 37.18 | 36.13 | 31.39 | 30.82 |
| Protein (%) | 11.65 | 12.29 | 37.74 | 10.67 | 11.37 |
| Total sugar as invert | 2.78 | 16.85 | <2.0 | 14.10 | 14.55 |
| (%) | | | | | |
| Dry matter (%) | 78.70 | 62.65 | 63.87 | 68.62 | 69.19 |
| Crude fiber (%) | <0.20 | <0.20 | <0.20 | 0.40 | 0.50 |
| TDN (Total digestible | 78.00 | 60.06 | 61.23 | 60.39 | 65.87 |
| nutrients, %) | | | | | |
| ADF (Acid detergent | <0.20 | <0.20 | <0.20 | 0.55 | 0.50 |
| fiber, %) | | | | | |
| NEG (Net energy of | 0.67 | 0.46 | 0.47 | 0.38 | 0.50 |
| gain, mcal/lb) | | | | | |
| NEM (Net energy of | 0.53 | 0.67 | 0.68 | 0.59 | 0.73 |
| maintenance, mcal/lb) | | | | | |

*All the process samples were analyzed in duplicate.
¹The values for beet molasses were from http://www.mwagri.com/products/molasses.asp
²Manufactured by Biegert Enterprises, Inc.

Summary

Disclosed are methods of incorporating starch-rich grains or grain products into an aqueous nutritive medium, CMS, without applying exogenous heat and/or thickening agents while maintaining the stability of the suspension. Through the process, starch and gluten in grain seeds or flour can be released in a concentrated aqueous nutritive medium through enzymatic hydrolysis and mechanic grinding, and swell to form a stable liquid gel-like suspension with pH of 5-7 and viscosity of 500-800 cP at ambient temperature. In addition, this product shows a comparable nutritional profile to the commercial LFS.

### Example 2

### Grain Product, Condensed Beet Molasses Solubles and/or Corn Steep Liquor

Materials and Methods

Materials: Dry whole corn kernels were purchased from Des Moines Feed Company (IA). Whole kernels were further ground (Thomas-Wiley Laboratory Miller) into corn flour to <850 μm particle sizes (20 mesh). Condensed beet molasses solubles (CMS, density 1.32 g/ml, pH 7.95, 61.74% dry matter), corn steep liquor, also known as condensed fermented corn extractives, (CSL, density 1.21 g/mL, pH 3.60, 49.92% dry matter) and liquid feed supplement (LFS, density 1.36 g/ml, pH 5.21, 63.03% dry matter) were samples provided by Biegert Enterprises. Protease (Bromelain, 1000 CDU/mg) was purchased from Sigma (B-4882). Protease (Neutrase® 5.0 BG, 1,810,000 U/g) and pullulanase (Dextrozyme®, 510 NPUN/g) were obtained from Novozyme (Denmark); α-amylase (Validase®, 340,000 MWU/g) and keratinase (Versazyme™, 400,000 U/g) were obtained from Valley Research Inc. (South Bend, Ind.) and BioResource Int. Inc. (Raleigh, N.C.), respectively. All other chemicals and supplies were purchased from Fisher Scientific.

Measurements: The pH was measured using a Model 520A pH meter (Orion). The viscosity and dry matter were measured using a DV-II+viscometer (Brookfield) and MB45 moisture analyzer (Ohaus), respectively. Dry matter (DM) is defined as the percentage of feed that is not water. Stability was measured as the number of days that samples stayed homogenous and did not separate into layers. Flowability was defined as when the container is inverted, material will pour out. Using this method, flowability was compared against a standard material made of 27% CF in CMS with a viscosity of 500-800 cP at ambient temperature.

Methods: The process described in this Example 2 replaces CMS with either CSL or different ratios of a CSL and CMS mixture. In short, dry corn kernels were ground to corn flour (CF) of particle size <850 μm. CF (15-36%) was mixed with either CSL (100%), CMS (100%), or in a combination of CSL and CMS as indicated in the tables in the results section of this example. Percentages were calculated based on weight. Prior to the addition of enzyme, CMS was pH adjusted to 4-5 with 7.5 mL 12N HCl per 100 mL CMS, while CSL was pH adjusted to 4-5 with 2.8 mL 14.8N NH₄OH per 100 mL CSL. Unless otherwise indicated, the mixture of CSL/CMS was not pH adjusted. Then samples were incubated with 0.2 g of pullulanase (102 NPUN) and 0.006 g of α-amylase (2040 MWU) per 100 g CF at ambient temperature for 2-3 hours. Samples containing greater than 25% CF were hand mixed due to the thickness of the mixtures. To test the stability of the mixtures in the final LFS, the CF/CSL mixtures were subsequently blended with the LFS at a ratio of 1 to 3 and then liquefied with high shear blending for 4-5 minutes. The resulting samples were stored in a container covered with Parafilm® at ambient temperature.

Results and Discussion

Replacement of CMS in the High Dry Matter Product with CSL

The studies discussed in Example 1 showed that the treatment of corn flour (CF) (<850 μm) with pullulanase could generate a stable suspension after being mixed with CMS. In the present study, CMS was substituted with CSL to allow better flexibility as a raw material for the feed manufacturer. A similar process described previously was used, except that the ratio of CF and CSL was altered to obtain a minimum of 65% dry matter. Table 5 shows the observed flowability and actual dry matter content of the different ratios of CF and CSL.

TABLE 5
Dry Matter (DM) Content and Flowability of Mixtures
with Different Ratios of Corn Flour (CF) and
Corn Steep Liquor (CSL) at pH 3.6¹

| Theoretical | Actual | CF | CSL | |
|---|---|---|---|---|
| DM (%)² | DM (%) | (%) | (%) | Flowability³ |
| 70 | 71.56 | 47 | 53 | No |
| 67 | 68.51 | 40 | 60 | No |
| 65 | 66.79 | 36 | 64 | No |
| 62 | NT | 27 | 73 | Yes |
| 61 | NT | 26 | 74 | Yes |

¹Percentages were calculated based on weight.
²% DM (CF) = 92.98, % DM (CSL) = 49.92.
³Qualitative Results: Flowability is defined as when container is inverted, material will pour out.
NT = Not Tested.

Although the mixture was not flowable, the 65% DM CF/CSL mixture was still mixed with the LFS at a ratio of 30:70 (CF/CSL: LFS) under high or low shearing conditions. The flowability and pH of the products resulting from these different treatments are summarized in Table 6. Interestingly, the replacement of 30% of the LFS with 65% DM CF/CSL resulted in a flowable and stable suspension with a final pH of 5.3-5.4 and 63% dry matter. Furthermore, the shearing force did not affect the stability of the final mixture.

TABLE 6
The Effect of Shearing on Flowabilitv of Corn Flour (CF)
and Corn Steep Liquor (CSL) Mixture Blended with Liquid
Feed Supplement (LFS) with 63% Final Dry Matter¹

| Shearing | | |
|---|---|---|
| N = 2 | Flowability² | Final pH |
| High | Yes | 5.4 |
| Low | Yes | 5.3 |

¹70% LFS (pH 5.21, % DM = 63.03) and 30% CF/CSL (pH 4.43, DM = 66.79), percentage is based on weight.
²Qualitative Results: Flowability is defined as when container is inverted, material will pour out.

Replacement of CMS in the High Dry Matter Product with CSL/CMS Mixtures

One option for attempting to improve economics of the CF/CSL and improve the flowability of the product is to mix CF with different ratios of CSL and CMS. Table 7 shows the results of flowability and actual dry matter content of the mixtures with different ratios of CF, CSL, and CMS. The samples comprised of 30-36% CF resulted in a dry mixture that was not flowable whereas the 15-27% CF samples were flowable.

TABLE 7
Dry Matter (DM) Content, and Flowability of Mixtures of Different
Ratios of Corn Flour (CF) and Various Combinations of Both Condensed
Molasses Solubles (CMS) and Corn Steep Liquor (CSL)¹

| Theoretical | Actual | CF | CSL | CMS | | |
|---|---|---|---|---|---|---|
| DM (%)² | DM (%) | (%) | (%) | (%) | pH | Flowability³ |
| 65 | 66.79 | 36 | 64 | 0 | 3.60 | No |
| 65 | 66.65 | 30 | 51 | 19 | 4.45 | No |
| 65 | 65.80 | 25 | 38 | 37 | 5.07 | Yes |
| 65 | 67.04 | 20 | 26 | 54 | 5.54 | Yes |
| 65 | 65.51 | 15 | 13 | 72 | 6.11 | Yes |
| 70 | 69.19 | 27 | 0 | 73 | 7.90⁴ | Yes |

¹percentages based on weight.
²% DM (CF) = 92.98, % DM (CSL) = 49.92, % DM (CMS) = 61.74.
³Qualitative Results: Flowability is defined, as when container is inverted, material will pour out.
⁴pH is unadjusted in this particular mixture.

To assess the stability of the suspensions with and without enzyme treatment, a combination of CF and CSL/CMS were mixed together. The suspension stability, flowability, and pH of the product resulting from these different treatments are shown in Table 8. The control CF/CMS suspension exhibited suspension stability as previously reported in Example 1. The non-enzyme treated CF/CMS suspension settled out within 3 days, while the enzyme-treated CF/CMS suspension was stable for much longer (>10 days). Similarly, samples comprised of 15% CF and 13% CSL/72% CMS required enzyme addition to maintain the stability of the suspension for 12 days while samples without enzyme were stable for one day.

TABLE 8
The Effect of Enzyme Treatment on the Stability
and Flowability of Various Combinations of Corn
Flour (CF), Condensed Molasses Solubles (CMS) and
Corn Steep Liquor (CSL) with 65% Dry Matter¹

| CF (%) | | | Stability | | |
|---|---|---|---|---|---|
| N = 2 | CSL/CMS (%) | Enzyme | (days) | Flowability⁴ | Final pH⁵ |
| Control² | 0/100 | + | 11 | Yes | 5.7 |
| Control | 0/100 | − | 3 | Yes | 5.7 |
| 15 | 13/72 | + | 12 | Yes | 4.5 |
| 15 | 13/72 | − | 1 | Yes | 4.5 |

¹percentages based on weight.
²Control 25% CF.
³+102 NPUN of pullulanase, −no pullulanase.
⁴Qualitative Results: Flowability is defined as when container is inverted, material will pour out.
⁵100% CMS was pH adjust with HCL, 13/72% was pH adjusted with NH₄OH and other ratios CSL/CMS were not pH adjusted.

Summary

The current study investigated the replacement of CMS with CSL for a high dry matter carrier for use in liquid animal feed. When CF and CSL were mixed together in ratios to achieve a dry matter content of 65-70%, it was observed that the mixtures were very dry. To maintain a good flowability of the mixtures, mixtures of CF and CSL/CMS were prepared containing 65% dry matter and monitored for stability and flowability. Samples made of 15% CF, 13% CSL, and 72% CMS required pullulanase treatment to maintain the stability of the suspension for 12 days. Therefore, CF can be incorporated with CSL or CSL/CMS to produce a high dry matter carrier without applying exogenous heat and/or thickening agents and yet maintain the stability of the suspension. The formulations described herein present options to feed manufacturers who need flexibility in their sources of raw materials to produce a high dry matter carrier for liquid animal feed supplements.

### Example 3

### Grain Product and Whey

Materials and Methods

Materials. Whole dry corn kernels (8-10% moisture) were ground into flour using a Thomas-Wiley Laboratory Miller with a 2 mm mesh and is sometimes referred to herein as corn flour. Small-scale experimental products containing less than 600 g of corn flour were formulated using the in-house corn flour. Large-scale experimental products containing greater than 600 g of corn flour were formulated using industrial milled corn (13% moisture). Three different lots of whey (Norfolk, Nebr.). Pullulanase (Optimax®L-1000, 1000 ASPU/g) was supplied by Genencor International Inc. (Rochester, N.Y.). α-Amylase (Validase® HT 340L, 340000 MWU/g) was supplied by Valley Research (South Bend, Ind.). Another α-amylase, commercially called Multifect AA 21L (Spezyme® Fred, 17,400 LU/g) was provided by Genencor International Inc. Protease (Bromelain, 1000 CDU/mg) was purchased from Sigma (St. Louis, Mo.). Kemin Agrifoods North America supplied the mold inhibitor Grain SHIELD®. All other chemicals were purchased from Fisher Scientific (Pittsburgh, Pa.).

Measurements. pH was measured using a Model 520A pH meter (Orion Research, Inc., MA). Viscosity was measured using a DV-II+viscometer (Brookfield Engineering Laboratories, Inc., MA) at 200 rpm and ambient temperature, and recorded as centipoises (cP). Spindle #7 and spindle #3 were used for measuring a combination of corn and whey, and whey, respectively. Dry matter and moisture were measured using a MB45 moisture analyzer (Ohaus, Switzerland). Flowability was measured qualitatively as the ability to homogenously mix in a high-speed blender (Oster, 12 speed), an overhead stirrer (IKA Rw20 Dzm.n), or a fermentor (New Brunswick Scientific BioFlo 3000, 14-L). Moisture, DM, pH, crude protein, and total sugars as invert (TSI) of the large-scale samples were analyzed by SDK Laboratories, Inc. (Hutchinson, Kans.). Suspension stability was defined as a sample that did not visually separate into layers for up to 60 days at ambient temperature and appeared homogenous after mixing. Total aerobic bacteria counts were also measured on selected stability samples.

Process development. Initial experiments were conducted to assess the feasibility of using corn flour as the grain material and whey as the liquid carrier. First, whey was evaluated for changes in viscosity due to different chemical and physical treatments, such as exposure to sulfuric acid, high sheering, and heat. Next, different mixtures of whey and corn were examined in order to define the DM working range. Then whey and corn mixtures were treated with various amounts of enzyme and sulfuric acid at different incubation times and temperatures to evaluate the effects on viscosity. After determining the viscosity parameters of the whey and corn mixtures, two different processes were evaluated for manufacture of the final product. Process 3 is the Process 2 described above for the manufacture of a liquid animal feed supplement using CMS and ground corn, except that CMS was replaced with whey. Process 4 is the process developed during the course of this Example 3 that uses whey and ground corn. The pH, viscosity, and stability of the samples prepared using both Processes 3 and 4 were measured. All samples were stored at ambient temperature in containers covered with Parafilm®. All samples were examined as single replicates and viscosity measurements are represented as a range unless otherwise noted.

Process optimization. Process 3, under small-scale conditions, consisted of mixing 100 mL of whey with 275 g of laboratory-ground corn flour and incubating the mixture with 250-1000 U of pullulanase for 4 h at 37° C. The enzymatic hydrolysis was stopped by the addition of phosphoric acid to the mixture, up to 1% (w/w). Two hundred milliliters of whey was then added and blended under low shear settings for 1 min, followed by the addition of up to 0.5% (w/w) Grain SHIELD®.

In Process 4, under small-scale conditions, two whey conditions were examined, unaltered or pH adjusted. For pH-adjusted whey, 1000 mL of whey was mixed with concentrated sulfuric acid (37 NH₂SO₄) to a final pH 3.38. When the initial pH of the whey was below pH 6.0, then NaOH (50%, w/v) was used to raise the pH to 5.5-6.0. An aliquot of whey (250-350 mL) was mixed with 200 g of laboratory-ground corn flour and incubated at either ambient temperature or 37° C. for 0.5-24 h with either 800 U of protease, 340000 U of α-amylase (Validase HT 340L), or 6160-22620 U of α-amylase (Spezyme Fred). The samples rested overnight at ambient temperature prior to the addition of Grain SHIELD 0.5% (w/w).

Process 4, under scaled-up conditions, consisted of mixing 1.6 kg of industrial grade corn flour with 2.1 kg of whey in a 14-L BioFlo fermentation vessel. Two processes were examined, one in which the pH was adjusted to pH 5.5 with 6 mL concentrated H₂SO₄ and one in which the pH was left unaltered (pH 6.0). Following pH adjustment, 45936 U of α-amylase (Spezyme Fred) was added to each of the two mixtures and the mixtures were incubated for 26 h at 37° C. Samples (100 g) were collected at various intervals during the processing and frozen at −20° C. until analyses by SDK Labs. Grain SHIELD [0.5% (w/w)] was added to a portion of each of the suspensions prior to freezing at −20° C.

Stability. Whey (250 mL) was mixed with 200 g of laboratory-ground corn flour and incubated at 37° C. for 1.5 h with 6160 U α-amylase (Spezyme Fred). The samples rested overnight at ambient temperature prior to the addition of Grain SHIELD 0.5% (w/w). DM, viscosity, and total aerobic bacterial count were recorded at day 0 and day 50. Stability was observed through day 102.

Results

Physical parameters of whey and corn flour. Three different lots of whey were tested for moisture, DM, specific gravity, crude protein, pH, total sugar as invert (TSI), and viscosity. Table 9 shows the physical and chemical values of the different lots of whey. The whey samples were found to vary in viscosity between 20-180 cP and between pH 4.8-6.0.

TABLE 9
Physical and chemical values of different lots of whey

| Sam- | Mois- | Dry | Specific | Protein | | | |
|---|---|---|---|---|---|---|---|
| ple | ture | matter | gravity | crude | | TSI | Viscosity |
| lot # | (%) | (%) | (g/mL) | (%) | pH | (%) | (cP) |
| 1 | 64.60 | 35.40 | 1.180 | 5.12 | 6.03 | 16.1 | 66.5-68.5 |
| 2 | 58.20 | 41.80 | 1.183 | 4.05 | 4.80 | 16.5 | 20.0-40.0 |
| 3 | 66.95 | 33.05 | 1.127 | 3.71 | 5.47 | 14.2 | 160.0-180.0 |

In an attempt to improve the homogeneity of whey/ground corn mixtures, the texture of whey was altered using different treatments, such as changing the temperature (22° C. and 37° C.), high sheering, and pH adjustment with H₂SO₄. The effects on viscosity of pre-treating whey with chemical and physical treatments after 24 h of incubation are shown in Table 10. The viscosity of the samples subjected to both high sheering and heat increased as compared to the control samples. The whey samples that were pH adjusted to 3.53 and when subsequently heated had a viscosity similar to the control. Pre-treating the whey with 800 U of protease or 0.00037% dithiothreitol (DTT) for 2 h at 37° C. did not reduce viscosity (data not shown) as compared to the control. However, when the whey samples that were pretreated with protease and DTT were added to ground corn to achieve 65.9% DM and incubated for 2 h at 37° C., the resulting products were not pumpable after resting for 24 h at ambient temperature and had a similar viscosity to the control (data not shown).

TABLE 10
Effect on whey viscosity when pre-treated with
heat, high sheering, and sulfuric acid

| | Incubation Temperature | | |
|---|---|---|---|
| | (° C.) | | |
| Treatment | 24 h | pH | Viscosity (cP) |
| Control | 22 | 6.03 | 66.5-68.5 |
| High Sheering | 22 | 6.03 | 62.0-92.0 |
| Heat | 37 | 6.03 | 119.5-120.0 |
| Heat and Acid | 37 | 3.53 | 62.5-71.0 |

Corn kernels were either ground in-house or by an industrial mill. The DM, particle size, standard deviation, and particle distribution were determined for both types of ground corn (Table 11). The particle size was 368±1.95 μm and 389±2.55 μm for the in-house laboratory and industrial milled corn, respectively. The majority (37%) of the industrial milled corn particles resided in the 1000-micron range and >50% of the in-house laboratory milled corn particles were in the 425-micron range.

TABLE 11
Properties of ground corn from different sources

| | Dry Matter | Particle | Standard |
|---|---|---|---|
| Mill Type Corn | (%) | size (d_{gw}) μm | Deviation (S_{gw}) |
| In-House Laboratory | 91.65 | 368 | 1.95 |
| Industrial | 86.86 | 389 | 2.55 |

Initial Process development. After determining the physical properties of whey and ground corn, studies were conducted to determine the maximum DM content that would result in a flowable product. Flowability, viscosity, and DM of different samples are presented in Table 12. Samples with >67% DM were judged not to be flowable in a laboratory scale blender and had a viscosity range between 2200-7500 cP in the final formulated product. Samples comprised of whey and corn flour with <64% DM were mixable in the higher sheer blender and by an overhead stirrer, and therefore were judged to be flowable. Based on these preliminary viscosity results, subsequent product formulations were prepared using whey and corn flour mixtures with <64% DM.

TABLE 12
Physical properties of samples comprised
of in-house milled corn flour and whey

| Dry Matter (%) | Viscosity (cP) | Flowable |
|---|---|---|
| 55.53 | 300-360 | Yes |
| 63.53 | 800-900 | Yes |
| 67.86 | 2200-2400 | No |
| 73.34 | 6500-7500 | No |

Effects of enzyme treatment, mixing, and heat on viscosity of whey- and corn flour-formulated samples. Whey (pH 5.7) and corn flour were formulated to contain 52%, 57%, and 62% DM. Samples were then treated with 26692 U of α-amylase (Multifeet AA 21L; Spezyme Fred) and incubated at 37° C. for 4 or 24 h, with constant overhead stirring. The control samples consisting of the same DM formulation of corn flour and whey were incubated at ambient temperature without mixing or enzyme treatment. Following incubation, viscosity, DM, and pH of the samples were measured. The actual DM values were determined to be 54.88%, 61.16%, and 65.93% for the studied formulation. As shown in Table 13, incubation of the 61.16% and 65.93% DM formulations with enzyme for 4 h resulted in a 50% reduction in viscosity as compared to the controls. Incubation for 24 h did not result in better viscosity reduction over the 4 h incubation. Incubation of the 54% DM formulations with enzyme for 4 h resulted in a 16% reduction in viscosity, whereas the same DM formulation incubated with enzyme for 24 h showed viscosities similar to the control. Two additional samples containing 68% DM and similar enzyme levels were incubated for 24 h at 37° C., with and without mixing (data not shown). These formulations had the texture of dry cookie dough and were not pumpable.

TABLE 13
Effect of enzyme treatment, mixing, and heat
on viscosity in samples comprised of corn flour
and whey after 4 and 24 h of incubation

| | | Incubation | | Dry | | |
|---|---|---|---|---|---|---|
| Corn | Whey | Temperature | Incubation | Matter | | Viscosity |
| flour (g) | (mL) | (° C.) | Time (h) | (%) | pH | (cP) |
| 100, | 350 | 22 | 24 | ND² | ND | 240 |
| Control | | | | | | |
| 100 | 350 | 37 | 4 | 54.88 | 5.46 | 200 |
| 100 | 350 | 37 | 24 | ND | ND | 280 |
| 150, | 300 | 22 | 24 | ND | ND | 800 |
| Control | | | | | | |
| 150 | 300 | 37 | 4 | 61.16 | 5.36 | 400 |
| 150 | 300 | 37 | 24 | ND | ND | 640 |
| 200, | 250 | 22 | 24 | ND | ND | 3300 |
| Control | | | | | | |
| 200 | 250 | 37 | 4 | 65.93 | 5.40 | 1500 |
| 200 | 250 | 37 | 24 | N/A | N/A | N/A |

ND, not determined and N/A, not available

Effect of incubation time, enzyme levels, and pH on viscosity of whey and corn flour samples. After the formulations for DM were established, incubation times, enzyme levels, and pH were examined, with the ultimate goal of producing a flowable product with viscosity <3000 cP. Samples incubated for 0.5 h, 1 h, 2 h, and 24 h with 26692 U of α-amylase (Spezyme Fred) had viscosities of 1400-1600 cP, 850-1000 cP, 900-1000 cP, and 520-540 cP, respectively. All the samples contained between 61-65% DM. The viscosity of the samples that were incubated for 0.5 h were nominally lower than the control with no enzyme treatment. In addition, there was little difference in viscosity observed between samples incubated for 1 h, 1.5 h, and 2 h. Incubation of samples for 24 h resulted in the lowest viscosity (520-540 cP).

The enzyme level required to reduce viscosity and provide an economically feasible formulation was examined. Four conditions were investigated in which the same DM formulations were exposed to various levels of α-amylase. All the treatments using 6160, 12319, 26692 U of enzyme (Spezyme Fred) resulted in a similar decrease in viscosity (940-960 cP, 1100-1160 cP, and 1020-1080 cP, respectively). Additional processing options were also examined, such as elimination of constant mixing. Corn flour and whey were mixed with 174000 U of enzyme and incubated without mixing for 24 h at 37° C. The viscosity of the resulting product (1060-1240 cP) was similar to formulations using lower levels of enzyme with continuous mixing.

pH. The pH of whey can vary from lot to lot, therefore, whey was pH adjusted to 4.5 to mimic the lower pH conditions of the whey that the customer might provide. Whey was tested at a pH between pH 5.5-5.8, which is the optimal pH range for α-amylase efficiency. The results showed that viscosities of whey and corn at both pH 4.5 and 5.7 were similar (940-1080 cP and 1020-1080 cP, respectively). These results were confirmed using a lower enzyme level (6160 U of Spezyme Fred), where whey at both pH 4.5 and 5.7 showed similar viscosity trends (580-600 cP and 720-740 cP, respectively).

Stability of whey and corn flour mixtures. Two small-scale samples were examined for stability using the formulation produced by Process 4. The 50-day stability results are shown in Table 14. Viscosity of the samples changed slightly over time, but the DM remained similar. Addition of Grain SHIELD appeared to reduce total aerobic count (TAC), reported as colony forming units (cfu), over time. Stability did not include testing for fungal and mold counts, however there were no overt visual signs of fungal contamination on the surface of the mixture. Samples were observed at day 102 and appeared stable.

TABLE 14
Stability of suspensions containing corn flour, whey, and 6160 U of
α-amylase (Spezyme Fred) through 50 days at ambient temperature

| Whey | Stable at | DM 0 d | DM 50 d | TSI 50 d | Viscosity 0 d | Viscosity 50 d | TAC 0 d | TAC 50 d |
|---|---|---|---|---|---|---|---|---|
| (pH) | 50 d | (%) | (%) | (dry basis, %) | (cP) | (cP) | (cfu/g) | (cfu/g) |
| 5.7 | Yes | 63.25 | 63.86 | 21.3 | 720-740 | 980-1040 | 5.0E+4-6.0E+4 | 8.0E+2-1.7E+3 |
| 4.5 | Yes | 63.22 | 64.25 | 21.8 | 580-600 | 680-690 | 5.0E+4-6.0E+4 | 8.0E+2-1.7E+3 |

Scale-up of whey and corn flour mixtures. Process 4 was scaled up in a 14-L BioFlo fermentor. Two batches containing 3-4 kg of corn/whey formulated product, with DM between 58-61%, were prepared in the fermentors. The whey used in the scale-up experiments was either unaltered (pH 6.0) or pH adjusted (5.5) prior to the addition of the corn flour. The experiments were run in duplicate and the results are summarized in Table 15. TSI increased after the addition of enzyme and reached up to 25-27% on a dry matter basis. pH was not continuously monitored throughout the process, however the pH of samples taken throughout the course of the reaction did not differ widely. A complete analysis of the finished formulated product, based on the DM, was preformed on the 2 and 26 h samples from Lot 2; these results are shown in Table 16. The 26 h sample showed an increase in glucose (6.50%±0.42) and lactose (18.40%±1.56).

TABLE 15
Physical and chemical profiles of two
lots of scaled-up whey/corn products

| | Incuba- | Moisture by | | | |
|---|---|---|---|---|---|
| Sam- | tion | Vacuum | Dry Matter | | TSI (dry |
| ple¹ | Time | Oven (%) | (%) | pH | basis) |
| Lot | 0 | 41.90 ± 0.28 | 58.11 ± 0.28 | 6.06 ± 0.06 | 14.95 ± 1.06 |
| 1 | 1 | 41.89 ± 0.45 | 58.12 ± 0.45 | 6.09 ± 0.03 | 25.90 ± 0.42 |
| | 2 | 41.73 ± 0.46 | 58.28 ± 0.46 | 6.05 ± 0.05 | 22.65 ± 1.91 |
| | 4 | 41.22 ± 0.11 | 58.78 ± 0.11 | 6.02 ± 0.05 | 21.00 ± 6.22 |
| | 6 | 40.97 ± 0.18 | 59.05 ± 0.21 | 5.91 ± 0.09 | 21.50 ± 2.26 |
| | 10.5 | 40.03 ± 0.45 | 59.97 ± 0.45 | 6.01 ± 0.02 | 25.35 ± 0.92 |
| | 27.5 | 39.53 ± 0.09 | 60.45 ± 0.04 | 6.03 ± 0.02 | 23.15 ± 0.49 |
| Lot | 0 | 39.89 ± 0.99 | 60.12 ± 0.99 | 5.74 ± 0.01 | 18.10 ± 3.96 |
| 2 | 1 | 40.55 ± 0.38 | 59.45 ± 0.38 | 5.71 ± 0.02 | 19.00 ± 2.26 |
| | 2 | 40.58 ± 0.16 | 59.43 ± 0.16 | 5.31 ± 0.03 | 18.85 ± 0.92 |
| | 4 | 40.46 ± 0.08 | 59.54 ± 0.09 | 5.64 ± 0.03 | 22.85 ± 6.72 |
| | 6 | 39.41 ± 0.49 | 60.59 ± 0.50 | 5.63 ± 0.01 | 11.90 ± 0.42 |
| | 22 | 39.15 ± 0.36 | 60.86 ± 0.36 | 5.43 ± 0.17 | 13.70 ± 0.99 |
| | 26 | 40.46 ± 0.21 | 59.54 ± 0.21 | 5.65 ± 0.01 | 27.45 ± 1.77 |

¹All data are from materials as received and were tested by SDK Laboratories (KS)

TABLE 16
Complete nutritional profiles of scale-up whey/corn
products after 2 h and 26 h reaction times

| | 2 h reaction | 26 h reaction |
|---|---|---|
| | (%, by dry basis) | (%, by dry basis) |
| Protein, crude | 8.94 ± 0.02 | 8.92 ± 0.23 |
| Calcium | 0.75 ± 0.01 | 0.69 ± 0.00 |
| Phosphorus | 1.13 ± 0.03 | 1.12 ± 0.01 |
| Potassium | 2.20 ± 0.06 | 1.43 ± 1.03 |
| Fructose | 0.70 ± 0.00 | 0.70 ± 0.00 |
| Glucose | 3.35 ± 0.92 | 6.50 ± 0.42 |
| Lactose | 12.70 ± 0.85 | 18.40 ± 1.56 |
| Maltose | 1.95 ± 0.64 | 2.00 ± 0.00 |
| Sucrose | 0.20 ± 0.14 | 0.10 ± 0.00 |

Discussion

It was hypothesized that if the viscosity of whey could be reduced it might result in a formulation that could contain larger amounts of corn and consequently a higher DM content. Because changing the texture of liquids by the folding and unfolding of globular proteins has been shown to increase their interaction with other ingredients, it was thought that this scenario could be applied to the whey and corn product. Additionally, high shearing has been shown to alter the conformational structure of whey proteins through partial denaturation, thereby exposing groups that are normally concealed in the native protein (Ennis, M. P., and D. M. Mulvihill. 2002. Milk proteins. Pp 189-217 in Handbook of Hydrocolloids. G. O. Phillips and P. A. Williams, ed. CRC Press, Boca Raton, Fla.; Onwulata, C., Isobe, S., Tomasula, P., and Cooke, P. 2006. Properties of whey proteins isolates extruded under acidic and alkaline conditions. J. Dairy Sci. 89:71-81). Manipulations of temperature, pH, the interaction pH and temperature, and sheer force were examined.

As the extent of denaturing is determined by protein concentration, temperature, time, and pH, these conditions were examined to determine whether they would affect the viscosity of whey. Elevated temperatures (65-70° C.) unfold and unmask S—H groups in proteins and have been shown to denature two major whey protein isolates, α-lactalbumin and β-lactoglobulin (Kim, C. and Maga, J. 1987. Properties of extruded whey protein concentrate and cereal flour blends. Lebensm. Wiss. Technol. 20:311-318; Linden, G. and Lorient, D. 1999. The exploration of by-products. Pp 184-210 in New Ingredients in Food Processing: Biochemistry and Agriculture. ed. CRC Press, Boca Raton, Fla.). High sheering of whey slightly decreased the viscosity of the sample, whereas heating whey to 37° C. for 24 h slightly increased viscosity. Heat theoretically should decrease the viscosity of whey, but the present results showed otherwise, possibly because our samples did not reach the optimal denaturing temperature of 65° C. Reducing the pH of whey to 3.5 and incubating it at 37° C. reduced its viscosity, but viscosity still remained similar to the control. A variety of proteases have also been used to unfold whey proteins, resulting in altered solubility, viscosity, emulsion, and foaming properties (Bertrand-Harb, C., Baday, A., Dalgalarrondo, M., Chobert, J.-M., and Haertle, T. 2002. Thermal modifications of structure and co-denaturation of α-lactalbumin and β-lactoglobulin induce changes of solubility and susceptibility to protease. Nahrung/Food. (46) 4:283-289; Van Der Ven, C., Gruppen, H., De Bont, D., and Voragen, A. 2002. Correlation between biochemical characteristics and foam-forming and -stabilizing ability of whey and casein hydrolysates. J. Agric. Food Chem. 50:2938-2946). However, in this study treatment of whey and corn mixtures with 800,000 U of protease did not reduce viscosity over the control. Furthermore, a high level of DTT, an agent used to break S—H in proteins, did not improve the viscosity of the whey. Additional experiments to decrease viscosity of whey may provide an avenue for further increasing dry matter content.

The effect of enzyme treatment on viscosity is dependent on the ratio of whey and corn, the final DM content of the product, and the amount of enzyme acting on starch. A DM content greater than about 65% was found to have a texture of dry cookie dough that was not pumpable and therefore was not a feasible formulation. In the DM range between 56-60% the viscosity of the sample was reduced as a function of time, with 24 h incubation resulting in the lowest viscosity. Additional experiments were performed to examine enzyme-dependent reduction in viscosity using shorter incubation times. Whey and corn mixtures were treated with three levels of α-amylase and were incubated for 1.5 h. All three enzyme treatment levels showed similar reductions in viscosity.

Two of the corn/whey batches containing Grain SHIELD (0.5%, w/w) were examined for stability. The samples appeared homogenous after mixing on day 102. Because the two stability samples were formulated identically with the exception of the pH of whey, these data suggest that the enzyme treatment (6160 U) and lower pH can reduce viscosity. Over the course of the stability trials, DM content and viscosity increased slightly over time and total aerobic bacteria count decreased by only one log for whey and corn formulations.

A more detailed sugar profile was determined for samples incubated at 2 h and 26 h and showed that fructose, maltose, and sucrose levels were similar, but that glucose and lactose increased by 48% and 31%, respectively. Lactose has been shown to increase ruminal levels of butyrate (Schingoethe, D. J. 1990 Utilization of dairy products in animal feeds. In ADPI/CDR Dairy Products Technical Conference. Chicago, Ill.; Schingoethe, D. J. 1976. Whey utilization in animal feeding: a summary and evaluation. J. Dairy Sci. 59:566-570).

In summary, a process was developed to incorporate starch-rich grain and nutritive whey into a stable suspension, without applying thickening agents. The process delivers a high dry matter liquid feed with an enhanced inverts profile. The final product was flowable, pumpable, and stable for up to 102 days, with a pH of 4.6-6.0. In addition, the product was cost effective and showed a comparable nutritional profile to the commercial liquid feed supplement. One advantage of these products is that they can replace a portion of expensive raw ingredients, such as molasses, in known liquid feed products thereby reducing cost and maintaining an essential nutrient profile.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A process for making an animal feed product, comprising the steps of:
(a) providing a grain;
(b) adding a plant processing by-product and optionally water;
(c) adding an enzyme to create a mixture;
(d) incubating the mixture under conditions wherein the enzyme reacts with the grain and plant processing by-product; and
(e) processing the mixture to create a stable suspension.

2. A process as defined in claim 1, wherein the grain is selected from the group consisting of corn, wheat, barley, millet, oats, and rice.

3. A process as defined in claim 1, further comprising the step of soaking the grain prior to the incubation step.

4. A process as defined in claim 1, further comprising the step of grinding the grain prior to the incubation step.

5. A process as defined in claim 4, wherein the average particle size of the grain is reduced upon grinding to be less than 2000 μm.

6. A process as defined in claim 4, wherein the average particle size of the grain is reduced upon grinding to be less than 850 μm.

7. A process as defined in claim 1, wherein the processed plant by-product is selected from the group consisting of dried distillers grain solubles, condensed beet molasses, whey, and corn steep liquor.

8. A process as defined in claim 1, wherein the enzyme is selected from the group consisting of proteases, keratinases, α-amylases, and starch debranching enzymes.

9. A process as defined in claim 8, wherein the starch debranching enzyme is selected from the group consisting of isoamylase, amyloglucosidase, and pullulanase.

10. A process as defined in claim 1, wherein the ratio of grain to plant processing by-product is between 1:1 and 1:9.

11. A process as defined in claim 1, wherein the suspension has a viscosity between 60-2000 cP at room temperature.

12. A process as defined in claim 1, wherein the suspension remains homogenous for at least four days.

13. A process as defined in claim 1, wherein the processing step comprises high-shear mixing.

14. An animal feed product, comprising a stable, high dry matter suspension of a grain and a plant process by-product that have been enzymatically reacted at a temperature insufficient to gelatinize starch components.

15. An animal feed product as defined in claim 14, wherein the grain is selected from the group consisting of corn, wheat, barley, millet, oats, and rice.

16. An animal feed product as defined in claim 14, wherein the grain has been ground to a flour.

17. An animal feed product as defined in claim 16, wherein the average particle size of the grain is reduced upon grinding to be less than 2000 μm.

18. An animal feed product as defined in claim 17, wherein the average particle size of the grain is reduced upon grinding to be less than 850 μm.

19. An animal feed product as defined in claim 14, wherein the processed plant by-product is selected from the group consisting of dried distillers grain soluble, condensed beet molasses, whey, and corn steep liquor.

20. An animal feed product as defined in claim 14, wherein the enzyme is selected from the group consisting of proteases, keratinases, amylases, and starch debranching enzymes.

21. An animal feed product as defined in claim 20, wherein the starch debranching enzyme is selected from the group consisting of isoamylase, amyloglucosidase, and pullulanase.

22. An animal feed product as defined in claim 14, wherein the ratio of grain to plant processing by-product is between 1:1 and 1:9.

23. An animal feed product as defined in claim 14, wherein the suspension has a viscosity between 60-2000 cP at room temperature.

24. An animal feed product as defined in claim 14, wherein the suspension remains homogenous for at least four days.
